(19) United States
(12) Patent Application Publication
(10) Pub. No.: US 2006/0251285 A1
(43) Pub. Date: Nov. 9, 2006

(54) [SURGE-PROOF DAMPER]

(75) Inventor: Yen-Chen Chan, TAIPEI (TW)

Correspondence Address: YEN-CHEN CHAN, P.O. BOX 108-00403, TAIPEI, TW

(73) Assignee: Mrs. Yen-Chen Chan, Hsin-Chuang City (TW)

(21) Appl. No.: 10/908,273

(22) Filed: May 5, 2005

(51) Int. Cl. H04R 1/00; H04R 9/06; H04R 11/02

(52) U.S. Cl. 381/404; 381/410

(57) ABSTRACT

A surge-proof damper for use in a speaker is disclosed to include a damper body made of an elastic material by cross-weaving, a plurality of reinforcing pads made of an elastic material by cross-weaving and fastened to the damper body by stitches or a bonding agent to affix lead wires to the damper body and to have the woven pattern extending at an angle relative to the extending direction of the woven pattern of the damper body to reinforce the structural strength of the damper body against horizontal and vertical stress.

### BACKGROUND OF THE INVENTION

1. Field of the Invention

The present invention relates to a speaker and more particularly, to a surge-proof damper for speaker, which has a high structural strength against surge and which prevents disconnection of lead wires.

2. Description of the Related Art

A speaker is an electro-acoustic transducer that converts electrical signals into sounds loud enough to be heard at a distance. A speaker includes a speaker unite and a cabinet. With respect to the technology, speaker is a matured product. Under severe market competition, suppliers are continuously providing different designs of speakers to attract consumers. The sound quality is one of the most important factors to be taken into account when designing a speaker. Speaker parts such as cone paper, damper, voice coil, and bonding agent are also important parts that affect the sound quality of the speaker.

The damper of a conventional speaker is made of fiber cloth, for example, cotton, cambric, nylon, and provided between the speaker body and the voice coil. Further, lead wires are used and connected to the signal terminals of the speaker body for the transmission of external signal to the voice coil. These lead wires are suspending over the top side of the damper. During operation of the speaker, the lead wires are vibrated with the produced sound waves. The vibration of the lead wires is the so-called jumping rope phenomenon. After long uses, this resonance action may cause the lead wires to break, or to be disconnected accidentally when unpacking the speaker, resulting in an interruption of signal transmission. In order to eliminate this problem, there are designs to have the lead wires arranged on the surface of the damper. As shown in FIG. 4, the damper A is a disk-like member made of elastic material by cross-weaving. During weaving, the lead wires B are alternatively inserted over the top and bottom surfaces A1 of the damper A. During operation of the speaker, the damper A gives a support to the lead wires B, preventing vibration of the lead wires B in the open air (jumping rope phenomenon). However, this arrangement still has drawbacks. When unpacking or mounting the damper A, the lead wires B may be stretched accidentally, causing damage to the surfaces A1 of the damper A. A minor damage of the surfaces A1 of the damper A causes abnormal vibration of the damper A during operation of the speaker, thereby affecting the sound quality. Further, breaking of the surfaces A1 of the damper A greatly shortens the service life of the damper A. Further, the arrangement of the lead wires B in the damper A causes a part of the damper A to curve outwards or downwards. Uneven curve of the top and bottom surfaces A1 of the damper A destructs the structure strength of the body of the damper A, thereby affecting the sound quality and service life of the speaker

### SUMMARY OF THE INVENTION

The present invention has been accomplished under the circumstances in view. It is therefore the main object of the present invention to provide a surge-proof damper, which protects the lead wires, preventing breaking or disconnection of the lead wires during operation of the speaker. It is another object of the present invention to provide a surge-proof damper, which is durable in use. To achieve these and other objects of the present invention, the surge-proof damper comprises a damper body made of an elastic material by cross-weaving, and a plurality of reinforcing pads made of an elastic material by cross-weaving and fastened to the damper body by stitches or a bonding agent to affix lead wires to the damper body and to reinforce the structural strength of the damper body. The reinforcing pads and the damper body have the respective woven patterns extending at an angle relative to each other so that the reinforcing pads reinforces the structural strength of the damper body against horizontal and vertical stress.

### BRIEF DESCRIPTION OF THE DRAWINGS

FIG. 1 is an exploded view of a surge-proof damper according to the present invention.

FIG. 2 is a perspective assembly view of the surge-proof damper shown in FIG. 1.

FIG. 2A is a top view in an enlarged scale of a part of the surge-proof damper shown in FIG. 2.

FIG. 3 is a perspective assembly view of an alternate form of the surge-proof damper according to the present invention.

FIG. 4 is a perspective view showing the arrangement of lead wires in a damper according to the prior art.

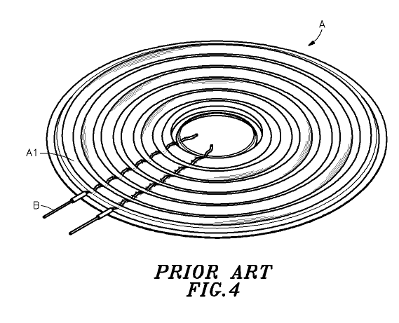

### DETAILED DESCRIPTION OF THE PREFERRED EMBODIMENT

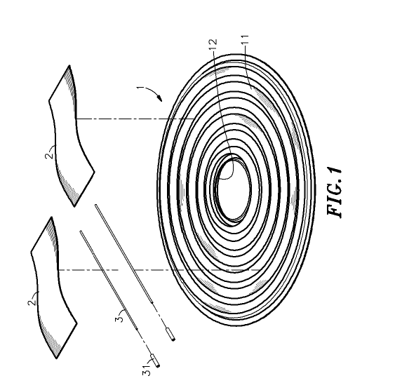

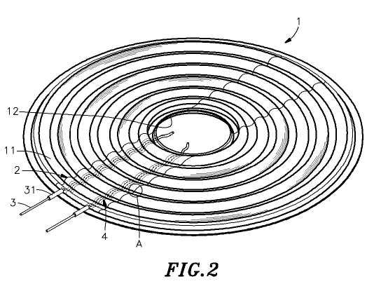

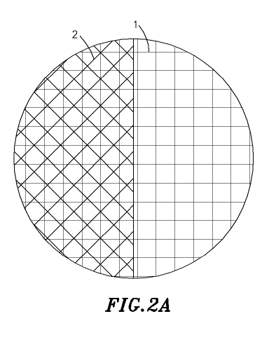

Referring to FIGS. 1 and 2, a surge-proof damper in accordance with the present invention is shown comprised of a damper body 1, reinforcing pads 2, and lead wires 3. The damper body 1 and the reinforcing pads 2 are made of elastic material by cross-weaving. The reinforcing pads 2 are arranged in pairs, and symmetrically fastened to the damper body 1 in such a manner that the woven pattern of the reinforcing pads 2 and the woven pattern of the damper body 1 extend at a particular angle, for example, 45° relative to each other (see FIG. 2A). The damper body 1 is shaped like a disk, having a center through hole 12 for the insertion of a voice coil (not shown) and a corrugated surface formed of annular folds 11 that extend one within the other around the center through hole 12. The lead wires 3 are soft and bendable metal wires set in between the damper body 1 and the reinforcing pads 2, each having an insulator 31 covered on a part thereof outside the periphery of the damper body 1 to prevent a short circuit due to contact between two lead wires 3 accidentally upon a vibration. Further, fastening means 4 is employed to affix the reinforcing pads 2 to the damper body 1 and also to affix the lead wires 3 to the damper body 1 and the reinforcing pads 2.

The lead wires 3 may be bonded to the top or bottom surface of the damper body 1, and arranged in parallel or across each other subject to the locations of the speaker signal terminals (not shown). The reinforcing pads 2 are arranged on the damper body 1 in same direction as the lead wires 3 with the woven pattern thereof extended at a particular angle relative to the woven pattern of the damper body 1. This arrangement prevents severe vibration of the lead wires 3 during operation of the speaker.

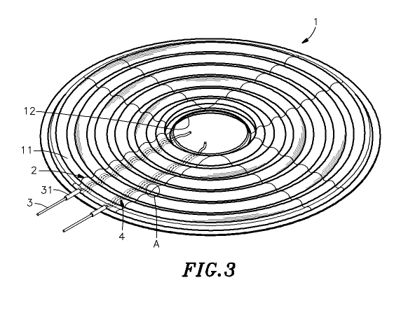

FIG. 3 shows an alternate form of the present invention. According to this embodiment, reinforcing pads 2 are radially arranged on the top surface of the damper body 1 and equiangularly spaced from one another around the center through hole 12 of the damper body 1. The design prevents severe vibration of the lead wires 3 during the operation of the speaker. Further, the reinforcing pads 2 reinforce the structural strength of the damper body 1 against horizontal stress as well as vertical stress.

As indicated above, the damper body 1 and the reinforcing pads 2 are made of elastic material by cross-weaving. The material for the damper body 1 and the reinforcing pads 2 can be fiber cloth obtained from cotton, cambric, nylon, etc. Further, the aforesaid fastening means 4 can be stitches, bonding agent, or their combination.

As indicated above, the invention provides a surge-proof damper, which has the following features.

1. Reinforcing pads 2 are used with fastening means 4 to secure lead wires 3 to the damper body 1, preventing disconnection of the lead wires 3 from the damper body 1 or displacement of the lead wires 3 relative to the damper body 1 during mounting or dismounting of the damper.

2. The reinforcing pads 2 are arranged on the damper body 1 to have the respective woven patterns extending at 45° relative to each other, thereby reinforcing the structural strength of the damper against horizontal stress as well as vertical stress and keeping the surface of the damper constantly smooth.

A prototype of surge-proof damper has been constructed with the features of FIGS. 1-3. The surge-proof damper functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A surge-proof damper comprising a plurality of reinforcing pads fastened to a damper body thereof to affix lead wires to said damper body, and fastening means to affix said reinforcing pads to said damper body, said reinforcing pads and said damper body being made of an elastic material by cross-weaving.

2. The surge-proof damper as claimed in claim 1, wherein said elastic material is selected from a material group including cotton, cambric, and nylon.

3. The surge-proof damper as claimed in claim 1, wherein said damper body is shaped like a disk, having a center through hole and corrugated top and bottom surfaces formed of annular folds extending one within another around said center through hole.

4. The surge-proof damper as claimed in claim 1, wherein said lead wires are soft, bendable metal wires.

5. The surge-proof damper as claimed in claim 1, wherein said lead wires each have a part extending out of said damper body and covered with an insulator.

6. The surge-proof damper as claimed in claim 1, wherein said fastening means is stitches.

7. The surge-proof damper as claimed in claim 1, wherein said fastening means is a bonding agent.

8. A surge-proof damper comprising a plurality of reinforcing pads fastened to a damper body thereof to affix lead wires to said damper body, and fastening means to affix said reinforcing pads to said damper body, said reinforcing pads and said damper body being made of an elastic material by cross-weaving, said reinforcing pads and said damper body having the respective woven patterns thereof extending relative to each other at an angle.

9. The surge-proof damper as claimed in claim 8, wherein said elastic material is selected from a material group including cotton, cambric, and nylon.

10. The surge-proof damper as claimed in claim 8, wherein said damper body is shaped like a disk, having a center through hole and corrugated top and bottom surfaces formed of annular folds extending one within another around said center through hole.

11. The surge-proof damper as claimed in claim 8, wherein said fastening means is stitches.

12. The surge-proof damper as claimed in claim 8, wherein said fastening means is a bonding agent.
